(19) United States
(12) Patent Application Publication
(10) Pub. No.: US 2022/0383340 A1
(43) Pub. Date: Dec. 1, 2022

(54) CROSS-ENTITY INVENTORY AND PERFORMANCE MONITORING SERVICE

(71) Applicant: NCR Corporation, Atlanta, GA (US)

(72) Inventors: Matthew Robert Burris, Atlanta, GA (US); Christopher John Costello, Suwanee, GA (US); Itamar David Laserson, Givat Shmuel (IL); Norman Leonard Trujillo, Frisco, TX (US)

(21) Appl. No.: 17/333,342

(22) Filed: May 28, 2021

(51) Int. Cl. G06Q 30/02; G06Q 10/08; G06Q 30/00; G06Q 10/10; G06K 9/00

(52) U.S. Cl. CPC G06Q 30/0201; G06Q 10/087; G06Q 30/0185; G06Q 10/10; G06K 9/00771; G06F 9/541

(57) ABSTRACT

A cross-entity and cross-retailer platform is provided that captures transaction data (associated with both in-store or on-line transactions), inventory data, and store planogram data for stores, indexes, and stores the data in a cloud-accessible data store. For any given store of a given retailer, metrics, aggregated totals for each metric, and correlations between the aggregated totals over intervals of time are maintained. Stocked inventory levels for items of the store and promotional compliance levels for promotions of the items within the stores are monitored and tracked using the metrics, aggregated totals, correlations, planograms, and promotion conditions associated with the promotions. When the stocked inventory levels and/or the compliance levels fall below thresholds select data and/or alerts are reported to the retailers and/or the entities. In an embodiment, select data is reported out to the retailers and/or entities at an end of each interval of time.

### BACKGROUND

Currently, suppliers have limited access to retail sales data for the merchandise that suppliers provide to retailers for sale. The sales data contains valuable information for marketing, product promotions, in-store product positioning, inventory, etc. Suppliers spend a significant amount of time and investment each year trying to obtain what data they can from the retailers. A significant time lag currently exists between the time the sales data is generated at the retailers and the time that third-party data service providers are actually able to supply the data to the suppliers (typically, a 4 to 6-week delay).

As a result, suppliers, in the best-case scenarios, receive time lagged sales data with little to no visibility into the their product inventories that are currently in stock with the retailers. Suppliers are usually provided no additional information with the sales data, which would be extremely valuable to the suppliers, such as retail store-level execution of their product promotions or online execution of their product promotions.

One specific area of concern for suppliers is performance monitoring of attractive locations and of endcap displays of their merchandise within the retail stores. Suppliers pay retailers significant premiums for shelf and display placement of their merchandise and may concurrently spend substantially on advertisements and other promotional activities to promote the merchandise. Yet, the suppliers largely rely on a manual process to determine when the inventory of the merchandise is low, missing from the store shelves, or largely depleted from endcap displays within the stores. When the stock of a product is low on a shelf or a display, consumers buy less of that product, which limits the sales of the promoted product. Today, the only way this is addressed is through weeks old retailer data or manual inspection of the shelves/displays and reporting by retailer staff present at the store or by a supplier's representative present at the store.

Additionally, the suppliers have no way of knowing the level of exposure their promoted merchandise is receiving at the stores. That is, the foot traffic of customers that pass by promoted merchandise displays and shelves is a black box to the supplier, such that the supplier has no way of knowing whether the promotion is a failure or was just not properly displayed or positioned by the store during the promotional period. There is also no demographic data available for the foot traffic, which can be significant in evaluating the performance of the promoted merchandise when a specific demographic is being targeted for the promotion.

### SUMMARY

In various embodiments, methods a system for cross-entity inventory and performance monitoring services are presented.

According to an embodiment, a method of operating a cross-entity inventory and performance monitoring service is presented. As an example, first metrics are maintained for sales of items at a store within a data store and second metrics are maintained for a planogram of the items located at the store within the data store. Correlations for the first metrics and the second metrics are derived based on transaction data associated with transactions of the store. An item inventory level for a given item within the store and a performance level for a promotion of the given item within the store are monitored in real time based on the first metrics, the second metrics, and the correlations.

### BRIEF DESCRIPTION OF THE DRAWINGS

FIG. 1 is a diagram of a system/platform for cross-entity inventory and performance monitoring services, according to an example embodiment.

FIG. 2 is a diagram of a method for operating a cross-entity inventory and performance monitoring service, according to an example embodiment.

FIG. 3 is a diagram of another method for operating a cross-entity inventory and performance monitoring service, according to an example embodiment.

### DETAILED DESCRIPTION

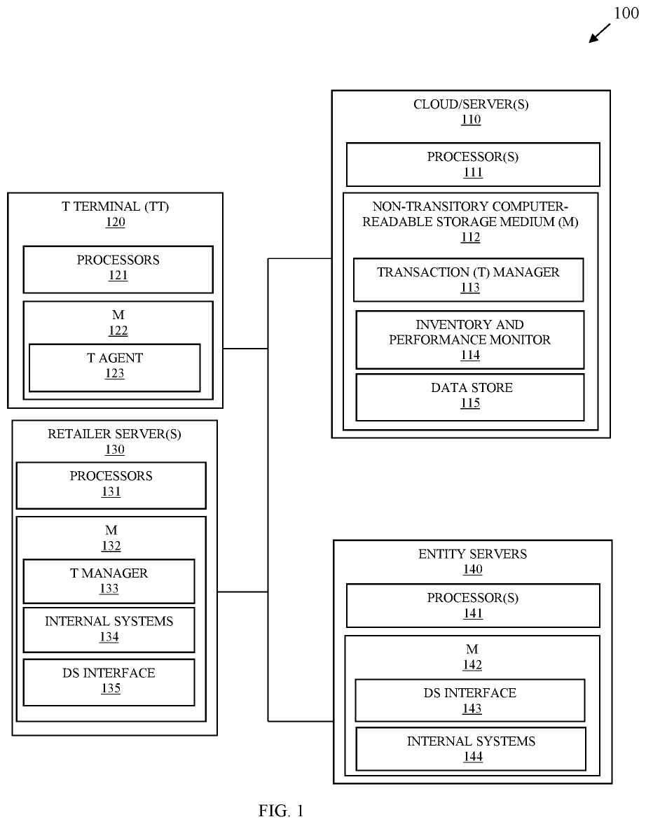

FIG. 1 is a diagram of a system/platform 100 for providing cross-entity inventory and performance monitoring services, according to an example embodiment. It is to be noted that the components are shown schematically in greatly simplified form, with only those components relevant to understanding of the embodiments being illustrated.

Furthermore, the various components (that are identified in system/platform 100) are illustrated and the arrangement of the components are presented for purposes of illustration only. It is to be noted that other arrangements with more or less components are possible without departing from the teachings of providing cross-entity inventory and performance monitoring services, presented herein and below.

System/platform 100 (herein after just “system 100”) provides a processing environment by which entities (e.g., Consumer Product Goods manufacturers (CPGs), item suppliers, and item distributors) and retailers can obtain real-time valuable store metrics, correlations, and reports item sales metrics, transaction metrics, planogram metrics, inventory metrics, promotion compliance metrics, and customer metrics, etc.

Each transaction at a store comprises a basket of items being purchased (it is to be noted that a basket may comprise a single item being purchased, or multiple items being purchased). The basket of items for a given transaction, provide valuable item identifiers and other information for the items, such as item category, item department, item description, item price, any redeemed item promotion, etc. Thus, the basket can be used to identify the departments visited by a given consumer based on a corresponding item purchased and the basket of items can be used to infer a path or journey of the given consumer through the store during the shopping trip (which is indication of other items or displays that the customer passed by and did not purchase during the their journey through the store for a transaction.

Other information available from the store may also be processed and considered as input by system 100, such as picker times for pickers that are fulfilling online transaction orders within the store, planogram details (when a planogram is available from a given store) that identify shelf locations and endcap displays of the store's items, etc.

When multiple transactions are evaluated to assemble the basket-based metrics for a given store and considered with the other information of the store. A variety of valuable metrics and correlations can be identified and derived. For example, when the retailer has no planogram a virtual, inferred, and derived planogram (herein after just “virtual planogram”) may be generated for a given store. Item sales can be aggregated across multiple retailer channels, inventory data, and basket data inventory data. A virtual planogram represents a set of data and relationships provided in a data structure for interface visualization and/or for Application Programming Interface (API) automated processing with internal systems of the retailer and entities associated with the items of the transactions. A given virtual planogram infers information about a given store's actual product layout within the store and proximities of the products to one another within the store provided in a logically generated product proximity mapping data structure or data object.

The virtual planogram (VP) derived for a given store (which does not have a planogram or is unwilling to provide an existing planogram) can then be consumed by the retailers and entities for insights and adjustments to item placements within a given store (shelf location, endcap displays, etc.) for purposes of maximizing item sales and the retailer gains valuable information about the traffic patterns within each of their stores to identify areas within the store associated with higher than normal item sales and lower than normal sales, such information may cause the retailer to adjust its existing planogram (if the retailer even has one) based on the provided virtual planogram. In fact, a variety of insights can be derived by the retailers and the entities in partnerships to provide preferred items together using the virtual planogram.

When a store has a planogram and supplies the planogram, the basket of items for each store transaction can be mapped to paths of the customers through the store, such that items passed over during the transaction can be readily identified and the foot traffic of the customers through the store can be determined for any given product's shelf location or endcap display. Any cameras associated with the store can supply real-time images of endcap displays and shelfs where stock levels of a given item can be determined, each item can be determined based on the planogram and image analysis of a given shelf or endcap display.

Additionally, basket analysis of the items in the transaction can be correlated with store inventory, such that specific item inventory levels can be determined based on the transactions and known item inventories for the store. The rate at which a given item is being sold can also be determined.

System 100 receives as input the transactions and corresponding transaction data of a given store being evaluated along with either a known planogram or a VP (derived from basket analysis of the transactions) and along with any images available from cameras at the store. The sales rate or items, items within specific item categories, and items of specific known store departments can be calculated. Customer foot paths through the store can be derived based on the basket analysis. Inventory levels can be estimated. Customer demographics for the foot paths can be determined for specific areas of the store (down to the aisle or lane). Any known promotion can then be monitored for compliance by the retailer and for performance along with inventory levels of the promoted item within the store. This information can be reported out in real time to the retailer or the entities associated with a given promotion and specific inventory needs can be delivered in real-time to retailer or entity specific inventory systems.

As an example, system 100 based on the various types of cross-entity data provided as input and maintained can provide reports and automated notifications or processing to the retailers and/or the entities or to the internal systems of the retailers/entities that:
1. provide the sales velocity as actionable trigger events to identify when endcaps or in-aisle merchandise displays are set up based on detected increases in the merchandise's sales velocity, identify normal sales velocity and when the sales velocity dips below a normal expected rate indicating stock depletion or shelf gaps that should be addressed by store staff, and identify when displays or endcaps stock is being depleted (based on reduction in the normal sales velocity;
2. link or connect sales velocity to basket analysis and planogram to provide indicators of the effectiveness of the planogram for the store, a region, and/or a type of store and to: link this data with actual image snapshots of shelves to verify for planogram compliance, identify when cycle counts and reset are occurring, and determine when the planogram may not be adhered to by staff of the store, provide demographic information with foot traffic analysis based on loyalty data associated with the transactions available from the retailer associated with the store and further linked to the basket analysis of the transactions; and
3. provide foot traffic analysis at the store's department level, item category level, and aisle level of detail based on the basket analysis and locational data, such as planogram or VP, in-store inventory, category labels, cycle counts, or resets and link the foot traffic to demographical analysis and/or shifts in demographics over time.

The term “item” may be used interchangeably and synonymously with the terms “product,” “merchandise,” and/or “good.”

As used herein the term “manufacturer” is used to identify a company that manufactures an item/product. A “supplier” is used to identify a company that supplies the item/product of a manufacturer to a distributor; in some instances, the supplier may also be the manufacturer of the item/product. A Consumer-Packaged Goods (CPG) company is an entity that manufacturers the item/product and then provides the item/product directly to a retailer for resale to a consumer. A distributor is used to identify a company that provides the item/product of a manufacturer (or a supplier that is also the manufacturer) directly to a retailer.

As used herein the term “company” or the term “entity” refers to a manufacturer, a supplier, a CPG, and/or a distributor.

The term “retailer” refers to an organization that resells an item/product directly to the consumer.

A “transaction terminal 120” is a type of device that is used to perform transactions, which may also include a variety of integrated peripheral devices or which may be interfaced to peripheral devices. The peripheral devices may comprise card readers, currency/coin acceptors and dispensers, scanners, weigh scales, integrated scanners with weigh scales, touch displays, cameras, etc.

A consumer device may also be considered a transaction terminal 120 when the consumer device is being operated by a consumer for purposes of performing a transaction, such that in some embodiments, the transaction terminal 120 is a phone, a laptop, a desktop, a tablet, a voice-based network-enabled device (Google® Home®, Amazon® Echo®, etc.), etc. Thus, a consumer device where the consumer purchases an item from a retailer via a browser is considered to be a transaction terminal 120 for that purchase that interacts with a retailer server 130 to purchase the item.

A retail staff operated device can also be a transaction terminal 120 when a staff member operates the device for purposes of performing a transaction on behalf of a customer. The staff operated device may be a Point-Of-Sale (POS) terminal, a tablet, a phone, a laptop, or a desktop.

In some cases, a consumer performs a self-checkout via a transaction terminal 120 located within a retail store, such that in these situations the transaction terminal 120 is a Self-Service Terminal (SST) or a kiosk.

System 100 comprises a cloud/server 110, a transaction terminal 120, retailer servers 130, and entity servers 140.

Cloud/Server 110 comprises at least one processor 111 and a non-transitory computer-readable storage medium 112. Medium 112 comprises executable instructions for transaction manager 113, inventory and performance monitor 114, and a data store 115 (the data store 115 residing in medium 112 and comprising executable instructions for querying and mining the data store 115). The executable instructions when provided to processor 111 from medium 112 cause processor 111 to perform the processing described herein and below with respect to 113-115.

Transaction terminal 120 comprises at least one processor 121 and a non-transitory computer-readable storage medium 122. Medium 122 comprises executable instructions for transaction agent 123. The executable instructions when provided to processor 121 cause processor 121 to perform the processing described herein and below with respect to agent 123.

Each retailer server 130 comprises one or more processors 131 and non-transitory computer-readable storage medium 132. Medium 132 comprises executable instructions for transaction manager 133, internal systems 134, and a data store interface 135. The executable instructions when provided to one or more processors 131 from medium 132 cause processors 131 to perform the processing described herein and below with respect to 133-135.

Each entity server 140 comprises one or more processors 141 and non-transitory computer-readable storage medium 142. Medium 142 comprises executable instructions for a data store interface 143 and internal systems 144. The executable instructions when provided to one or more processors 141 from medium 142 cause processors 141 to perform the processing described herein and below with respect to 143-144.

Terminal 120 performs transactions for selling items. Transaction agent 123 of retailer server 130 processes a transaction purchase workflow that interacts with transaction manager 133 for purposes of completing a transaction to sell one or more items to a consumer on behalf of a retailer at the retailer store or online (via a web-based or app-based interface—online transactions may utilize a consumer device as terminal 120 (such as consumer phone, tablet, laptop, desktop, etc.)).

Transaction agent 123 combined with internal systems 134 of each retailer may also combine to provide relevant information from online transactions that are scheduled for pickup or delivery. The transaction information of any order is provided by transaction agent 120 and transaction manager 133 and the picker information (staff member that fulfills the order by picking the items from the shelves), such as start pick time, end pick time, picker identifier, time of day, day of week, calendar date, season of year, etc. is provided by one of the retailer's internal systems 134. Other information may be gathered regarding the retailer from the internal systems 134 as well, such as any existing planogram, loyalty information for a customer, images of store shelves, displays, and endcap displays, etc.

Transaction manager 133 processes purchase transaction workflows through interaction with transaction agent 123. The purchase transaction workflow is enhanced and modified with the teachings presented herein, such that during purchase transaction, transaction manager 133 notifies transaction manager 113 of the transaction along with transaction data (may also be referred to as transaction details). The transaction data is gathered by transaction agent 123, by transaction manager 133, and any information gathered by internal fulfillment system 134 when an online transaction is being picked or fulfilled (such as picker information, planogram data, shelf/display images). Additional transaction data may also be provided by transaction manager 133 for each retailer's transaction using as product/item catalogue, and/or customer loyalty data stores.

Transaction data may comprise, a customer identifier (if available) for the customer associated with the transaction, a customer profile (if available) associated with the customer identifier, item codes for each item (such as Universal Product Code (UPC)) of the transaction, item pricing for each item of the transaction, item category for each item of the transaction, item description for each item of the transaction, a transaction type that identifies an item return transaction versus a purchase transaction, a channel identifier for a channel being used for the transaction (e.g., in person at a POS terminal 120, in person at a SST 120, online via a consumer device acting as terminal 120 through a mobile application of the consumer device, online via a specific e-commerce system using a browser, via a call center through an agent that operates a terminal 120, etc.), transaction identifier for the purchase transaction of all of the items being purchased by the customer, a terminal identifier for the terminal 120, a store identifier for the store associated with the item return, geographical location data for the store, any available planogram data for shelf locations of the items associated with the transaction within the store (note that this may not be provided and may not exist and is not needed with some embodiments herein but if it is available it can be included in the transaction data or augmented by the transaction manager 133 to be included with the transaction data), a retailer identifier for the retailer, a transaction history for the customer (if available), entity identifiers for the manufacturer, supplier, distributor, and/or CPG associated with the item codes (there may be one to several entity identifiers for a single item being purchased with the transaction), customer demographic data or customer segmentation data for the customer maintained in the loyalty data store (if available), calendar date for the item return, day of the week for the item return, time of day for the item return, a season associated with the calendar date, promotion identifiers for any promotions redeemed with the items of the transaction, promotion details for each redeemed promotion during the transaction, shelf/display images captured by one or more cameras in the store during the transaction, etc.

It is to be noted also terminal 120 may be a mobile device operated by the consumer (consumer device), such that the mobile device reports through transaction agent 123 a current geographical location of the mobile device using the device's location services.

Moreover, transaction data may comprise additional information available to retailer from their data stores or internal systems 134 from what was presented above or less information from what was presented above.

Further, customer profile data (when available) of the may comprise customer contact information (such as mobile device number, email address, social media identifiers, etc.), customer name, customer loyalty level, preferred contact channel of customer (e.g., via email, text, and/or voice call), etc.

Transaction manager 133 sends a transaction identifier for the transaction in real time along with the transaction data/details to transaction manager 113 of cloud 110 as items are purchased and the transaction is processed on terminal 120. Transaction manager 133 also gathers internal systems' data, such as picker information/data, inventory levels for items of the transaction before the transaction, images of shelves/displays, sends this internal systems' information/data to transaction manager 113 for the transaction.

Transaction manager 113 indexes, links, and stores the transaction data and internal system's data within data store 115 based on the retailer identifier for the retailer, e-commerce system identifier (if available for the entity that took a customer's online order associated with the transaction), store identifier, item categories or item types for each item of the transaction, the entity identifiers (for the manufacturer, supplier, distributor, and/or CPG) associated with each entity of each item of the transaction, the items' identifiers (UPCs) for the purchased items of the transaction, any promotion identifiers for any promotions redeemed during the transaction, and/or a customer identifier for the customer (if available).

Each record in data store 115 comprises transaction data or transaction details and any available internal systems' data that corresponds to the transaction. Furthermore, some retailers may comprise their own unique entity identifiers for distributors or suppliers, such that transaction/return manager 113 may maintain lookup tables that map a given distributor's or a given supplier's retail-specific entity identifier and associate it to a unique entity identifier for the given distributor or supplier maintained by cloud 110. The manufacturer of the purchased items are already assigned unique manufacturer identifiers available within the UPCs (item codes) of the transaction data for the transaction.

In some embodiments, mapping tables to distinguish unique customer identifiers across retailers may also be used by transaction/return manager 113 for purposes of identifying a unique customer across different retailers that is associated with different retailer-assigned customer identifiers. In this embodiment, a globally unique customer identifier for a customer may be maintained and managed by transaction manager 113 across a plurality of retailers.

Each transaction record of the data store 115 represents a single basket of items (again, can be a basket of 1 items) that was processed for a given retailer at a given store or fulfilled at the store by a picker and each transaction record includes or is linked to appropriate internal systems' data associated with the corresponding transaction, such as planogram (if available), shelf/display images, current item inventory levels for the items associated with the corresponding transaction, etc.

Inventory and performance monitor is notified when records are added to the data store 115. At predefined or configured intervals of time, based on a volume of records added to data store 115, and/or each time a transaction is completed and a record is added to data store 115, inventory and performance monitor mines the records associated with any given retailer and/or any given store and generates or updates a given VP for the given store based on the added transaction records and other transaction records for other transactions of the given store when an actual planogram is unavailable.

For a current transaction record of a given store, inventory and performance monitor obtains the item identifiers for the basket of items included within the transaction data of the current record and obtains the item categories and item departments that correspond to the item identifiers. An aggregated total for each item sold and its item category and item department are maintained over a given interval of time (for example for a past month, past week, past quarter, past 2 days, etc.). A historical total for each past interval of time is also maintained. For example, a week item X was sold at prices that varied for a total of sales price of N, item X is in item category Y and store department Z; each of the previous 51 weeks of the year also include their corresponding aggregated totals for item X and N.

Inventory and performance monitor also maintains with each interval (current and past intervals) a variety of other aggregated interval totals such as average pick time for online orders fulfilled during the interval, total number of online orders for the interval, item shelf replenishment notifications during the period, item display replenishment notifications, item safety stock adjustments, item challenges or issues recorded with item displays, item inventory levels, customer demographic designation totals by item, item category, item department, etc.

The aggregated totals for the current interval and the previous intervals for the item, the item category as a whole, the item department, and the other aggregated interval totals as a whole are then plotted on a graph or mathematically analyzed over intervals of time (current interval and past recorded intervals). This shows total sales of the item versus total sales of the item category versus the total sales of the item department over time with the current interval of time. Another graphing or mathematical analysis of each item categories (all items within a category) and of each item department (all items of all item categories within a department) is produced by the inventory and performance monitor 114. This shows total sales from item categories and item departments over time with the current interval of time. This process can be repeated for comparisons of sales for each of the above-referenced aggregated metric totals.

The graphs or the mathematical analysis allows inventory and performance monitor to derive correlations from the captured metrics/aggregated totals over time vis-vis the current interval of time, such as a current rate and changed rate over time for a given item's sales as a percentage of the category sales for the item category of the item and as a percentage of department sales for the item department associated with the item category within a given store, the departments most frequently visited during an in-store shopping trip of a consumer, the most frequented paths taken by a consumer through the store during an in-store shopping trip, the rate or velocity of item sales by departments, paths of customers based on demographics, paths of customers by specific shelves or displays/endcaps within the store, shelf stock dead zones or departments infrequently visited during shopping trips, hot zones for departments based on a sales velocity of particular items, increase or decrease rate or item inventories on shelves endcaps, etc.

Inventory and performance monitor 114 can also maintain aggregated metrics the intervals associated with analysis of images provided by cameras of the store of shelves and endcaps for each item using the planogram of VP. For example, image analysis may provide for a counting of each item present or an estimation of a total item count on a given shelf or display. The total item count per its location within the store can be maintained for each interval and a corresponding correlation over the intervals shows a rate at which the inventory levels are increasing or decreasing from interval to interval.

Inventory and performance monitor uses the correlations and aggregated metrics as input when processing a retailer-specific or entity-specific workflow. The workflow can identify specific items and/or specific promotions and provide for automated processing actions to internal systems 134 and 144 to be processed by the inventory and performance monitor when workflow defined conditions are detected. Additionally, the workflow can define when reports are to be generated and sent to the retailers and the entities. For example, a given entity workflow may indicates that an endcap display of a given promotional item is to maintain a certain amount of level of stocked items, when inventory and performance monitor determines from the correlations and aggregated metrics that the level of stocked items is below the amount required by the workflow, the inventory and performance monitor is instructed to produce a report and send a notification to the entity along with the current inventory amount/level. As another example, an entity workflow may indicate that a given promotional item is to be located on a specific shelf or endcap within the store, when inventory and performance monitor determines that this is not the case, the inventory and performance monitor is instructed to send the actual location of the promotional item within the store and a report to the entity. In another case, upon detecting a reduction in sales velocity of a given promotional item for a current interval or time, the workflow instructs the inventory and performance monitor to send current stocked inventory levels for the previous interval and the current interval as a notification along with a report to the entity. In still another scenario, when a current sales for a current period of a promotional item falls below a workflow set threshold, the inventory and performance monitor is instructed to send a report on the volume of foot traffic, and the customer demographics of the foot traffic at the store for the interval to the entity. In another case, a report may show a comparison of the average demographic and foot traffic over the intervals. In fact, the workflows can be customized per entity, per retailer, per promotional item by entity, per promotional item by retailer, etc.

The inventory and performance monitor generates or updates the metrics, aggregated totals for the metrics, and the correlations with each newly added transaction from a given store. A given entity's workflow or retailer's workflow may ask for a comparison report between different stores within a given geographical region for a given promoted item. For example, the average foot traffic is X for store B but Y for store C (where X is significantly higher than Y) but the sales for the promoted item is N for store X and M for store Y (where M is higher than X); so X has a much higher foot traffic rate but less sales than Y. In fact, the workflows can define comparisons and aggregations requested by the retailers or entities for purposes of visualizing performance of a promoted item across custom aggregations.

Again, each retailer and entity may also comprise its own workflow and may have multiple different workflows, such that with each additional record added to data store 115, inventory and performance monitor 114 obtains that retailer's or that entity's workflow(s) and processes the corresponding workflow(s). Inventory and performance monitor 114 pulls the transaction records that span multiple channels, retailers, and entities associated with the reporting interval along with the metrics/aggregated totals retained for the previous intervals and updates the current metrics/aggregated totals for the current interval, compares to the metrics/aggregated totals of the previous intervals and updates the correlations, and processes the corresponding workflows using the updated metrics/aggregated totals, the updated correlations, and the transaction data and internal systems' data that supports the information.

In some instances, the conditions evaluated within a given workflow may report that a current aggregated total for a given metric, a current correlation, and/or select data from the transaction data be reported in real time to an internal system 134 using an API specific to internal system 134 (for example an inventory system 134 when more items are required in inventory to meet the current demand; roll back a given promotion when the redemption rate exceeds a threshold; etc.) If the workflow being processed is for an entity associated with one of the items in a current transaction, inventory and performance monitor 114 in accordance with conditions of the entity's workflow may automatically and immediately report out a current aggregated total for a given metric, a current correlation, and/or select data from the transaction data in real time to an internal system 144 using an API.

Each entity/retailer workflow can custom define what event, what aggregated total for what tracked metric (per channel), what relationship, and/or what inference triggers an automated report out by inventory and performance monitor 114 to internal systems 134 and 144. Specific retailer/entity defined conditions, events, and time intervals can also be defined before an automated report out is triggered.

The internal systems 134 and 144 may comprising inventory systems, loyalty/promotion systems, schedule/delivery systems, ordering systems, etc. This allows for integration of real-time purchase transactions within each internal system 134 and 144.

Thus, inventory and performance monitor 114 acts as a real-time inventory and promotional item performance monitor of purchase transactions for each interested retailer and entity and when retailer/entity-defined conditions of workflows are met based on generated or updated metrics/aggregated totals and corresponding correlations, the reports and notifications are rendered to interfaces 135 and 142 and/or select portions of the data supporting the correlations are automatically reported to internal systems 134 and 144. This allows real-time item store placement decisions to be made by the retailers and the entities in cooperation with the retailers, real-time promotion decisions to be made, real-time inventory decisions to be made, and real-time item manufacturing and ordering decisions to be made, etc.

System/Platform 100 is completely automated and processed in real time and is employed via data store 115. Data store 115 is maintained and custom mined (based on each retailer's/entity's workflow(s)) by transaction/return manager 113 and inventory and performance monitor 114 to generate and update metrics/aggregated totals and correlations. At the same time, inventory and performance monitor 114 continuously updates existing metrics/aggregated totals and correlations with each new transaction at the stores such at any given point in time, the data store 115 reflects current metrics/aggregated totals and correlations. Inventory and performance monitor 114 delivers the metrics/aggregated totals and/or correlations to the corresponding retailers and entities via interfaces 135 and 143 when needed (based on tracked metrics, deviations in correlations, new or revised correlations between reporting periods/intervals defined within custom workflows for the retailers and entities and/or at the end of each reporting interval).

Additionally, both the retailers and the entities can access data store 115 and perform queries and generate reports via interface 135 of retailer servers 130 and via interface 143 of entity servers 140. That is, a user-facing interface to inventory and performance monitor 114 is provided through interface 135 to the retailers and is provided through interface 143 to the entities. The retailers and entities can provide custom search criteria through the user-facing interface to inventory and performance monitor 114. Inventory and performance monitor 114 then processes the search criteria against data store 115 and returns search results back to the entities or retailers via interfaces 143 and 135. Inventory and performance monitor 114 may also permit queries against the intervals and each interval's corresponding metrics/aggregated totals and calculated correlations through interfaces 135 and 143.

It is to be noted that data store 115 can be organized in any number of manners, such as via tables by retailer, tables by store of retailer, tables by entity, tables by type of item, etc. When inventory and performance monitor 114 processes the workflows, the appropriate tables needed that span multiple different retailers/entities or that are associated with just one retailer/entity or store of the retailer can be searched selectively. In this manner, transaction identifiers are unique for a given retailer or a given store within a given table, but the inventory and performance monitor 114 can search across multiple different tables associated with multiple different retailers/entities when conditions defined in a retailer/entity workflow dictate.

Each entity or retailer can have custom workflows for both item returns and purchase transactions. For example, an entity may have an item return workflow that notifies transaction manager 133 when a predefined total of number of items of a specific type are returned within an entity-set period of time over each of the channels. This can assist the entity in truck load planning and truck route planning. This is but one example and it is to be understood that a variety of retailer and entity-based needs can drive their item return workflows and purchase transaction workflows. Furthermore, the channel-based trends/patterns can be defined within the item return workflow similar to what was discussed above for the purchase transaction workflows, such that channel-based trends/patterns are discovered and reported for both purchase transactions and item returns.

Transaction manager 113, inventory and performance monitor 114, and data store 115 collective present and provide a real-time inventory and performance monitoring service to the retailers and the entities (providing the features and functions discussed herein). This allows retailers and entities to collaborate and to optimize item placement within a given store, item promotions, and item order/manufacture schedules.

In an embodiment, the reports associated with report outs are provided as interactive graphs to interfaces 135 and 143. The interactive graphs can be interacted with to obtain the data supporting any given metric, aggregated metric total, and/or correlation. Views of the interactive graph can be at any user-defined level of detail, such as fine grain or coarse grain.

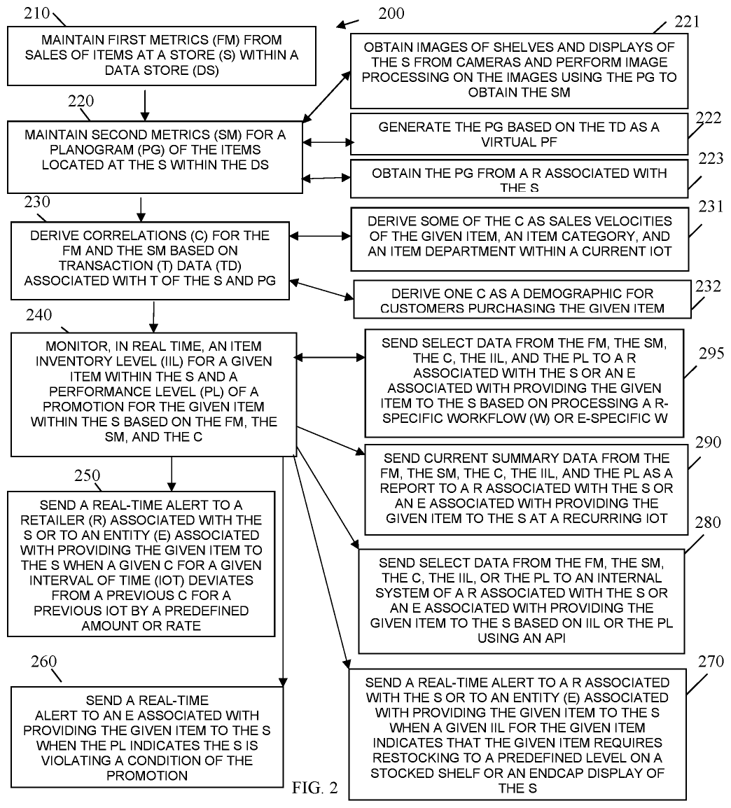

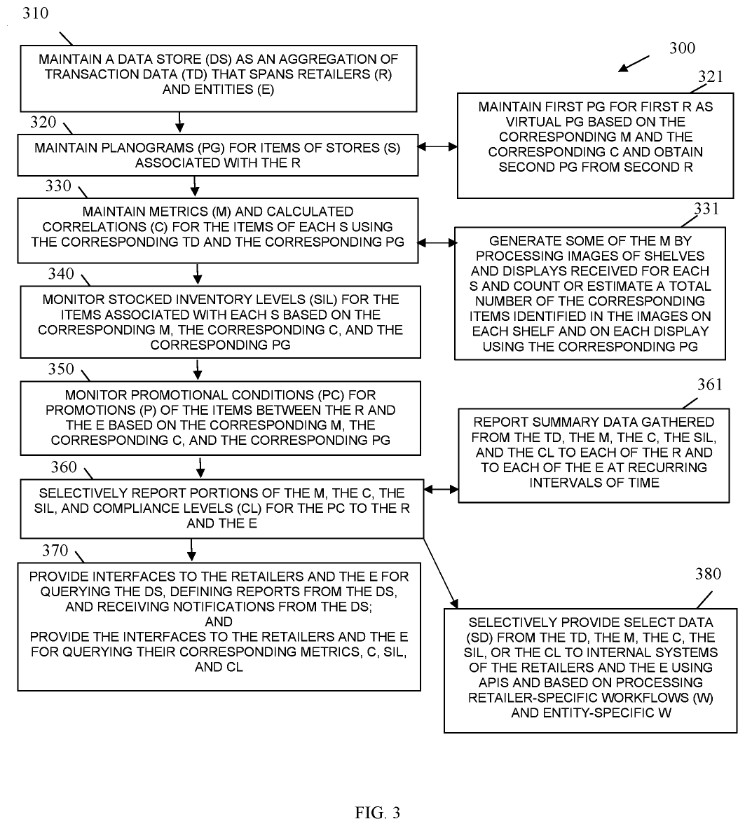

These and other embodiments are now discussed with reference to FIGS. 2-3.

FIG. 2 is a diagram of a method 200 for method for operating a cross-entity inventory and performance monitoring service, according to an example embodiment. The software module(s) that implements the method 200 is referred to as a “real-time store monitor.” The real-time store monitor is implemented as executable instructions programmed and residing within memory and/or a non-transitory computer-readable (processor-readable) storage medium and executed by one or more processors of one or more devices. The processor(s) of the device that executes the real-time store monitor are specifically configured and programmed to process the real-time store monitor. The real-time store monitor may have access to one or more network connections during its processing. The network connections can be wired, wireless, or a combination of wired and wireless.

In an embodiment, the device that executes the real-time store monitor is cloud 110. In an embodiment, cloud 110 comprises a plurality of servers logically cooperating and accessible as a single server 110 (cloud 110).

In an embodiment, the real-time store monitor is all or some combination of 113-115.

At 210, the real-time store monitor maintains first metrics from sales of items at a store within a data store 115.

At 220, the real-time store monitor maintains second metrics for a planogram of the items located at the store within the data store.

In an embodiment, at 221, the real-time store monitor obtains images of shelves and displays of the store from cameras and performs image analysis/processing on the images using the planogram to obtain the second metrics. For example, items stocked on a shelve of an endcap display can be counted or the number of items can be estimated through the image analysis. The items are recognized based on the planogram and known areas of the store that the camera is providing images of.

In an embodiment, at 222, the real-time store monitor generates the planogram based on the transaction data as a virtual planogram.

In an embodiment, at 223, the real-time store monitor obtains the planogram from a retailer associated with the store.

At 230, the real-time store monitor derives correlations for the first metrics and the second metrics based on the transaction data associated with the store and the planogram.

In an embodiment, at 231, the real-time store monitor derives some of the correlations as sales velocities of a given item, an item category of items to which the given item is associated, and an item department within the store where the given items and other items of the item category are located.

In an embodiment, at 232, the real-time store monitor derives at least one correlation as a model or a typical demographic for customers purchasing the given item from the store.

At 240, the real-time store monitor monitors, in real time, an item inventory level for the given item within the store and a performance level of a promotion associated with the given item within the store based on the first metrics, the second metrics, and the correlations.

In an embodiment, at 250, the real-time store monitor sends a real-time alert to a retailer associated with the store or to an entity associated with providing the given item to the store when a given correlation for a given interval of time deviates from a previous correlation for a previous interval of time by a predefined amount or rate.

In an embodiment, at 260, the real-time store monitor sends a real-time alert to an entity associated with providing the given item to the store when the performance level indicates the store is in violation of a condition associated with the promotion.

In an embodiment, at 270, the real-time store monitor sends a real-time alert to a retailer associated with the store or to an entity associated with providing the given item to the store when a given item inventory level for the given item indicates that the given item requires restocking or replenishment to a predefined level on a stocked shelf or an endcap display of the store.

In an embodiment, at 280, the real-time store monitor sends select data from the first metrics, the second metrics, the correlations, the item inventory level, or the performance level to an internal system of a retailer associated with the store or an entity associated with providing the given item to the store based on the item inventory level or the performance level using an API.

In an embodiment, at 290, the real-time store monitor sends current summary data from the first metrics, the second metrics, the correlations, the item inventory level, and the performance level as a report to a retailer associated with the store or to an entity associated with providing the given item to the store at a recurring interval of time.

In an embodiment, at 295, the real-time store monitor sends select data from the first metrics, the second metrics, the correlation, the item inventory level, and the performance level to a retailer associated with the store or an entity associated with providing the given item to the store based on processing a retailer-specific workflow or an entity-specific workflow.

FIG. 3 is a diagram of another method 300 for operating a cross-entity inventory and performance monitoring service, according to an example embodiment. The software module(s) that implements the method 300 is referred to as a “cloud-based real-time inventory and promotional item performance monitor.” The cloud-based real-time inventory and promotional item performance monitor is implemented as executable instructions programmed and residing within memory and/or a non-transitory computer-readable (processor-readable) storage medium and executed by one or more processors of a device. The processors that execute the cloud-based real-time inventory and promotional item performance monitor are specifically configured and programmed for processing the cloud-based real-time inventory and promotional item performance monitor. The cloud-based real-time inventory and promotional item performance monitor may have access to one or more network connections during its processing. The network connections can be wired, wireless, or a combination of wired and wireless.

In an embodiment, the device that executes the cloud-based real-time inventory and promotional item performance monitor is cloud 110. In an embodiment, the device that executes the item return transaction integration manager is server 110.

In an embodiment, the cloud-based real-time inventory and promotional item performance monitor is all of or some combination of 113-115 and/or method 200 of FIG. 2.

The cloud-based real-time inventory and promotional item performance monitor presents another and, in some ways, enhanced processing perspective of the what was discussed above for cloud 110 and method 200.

At 310, the cloud-based real-time inventory and promotional item performance monitor maintains a data store 115 as an aggregation of transaction data that spans retailers and entities.

At 320, the cloud-based real-time inventory and promotional item performance monitor maintains planograms for items of stores associated with the retailers.

In an embodiment, at 321, the cloud-based real-time inventory and promotional item performance monitor maintains first planograms for first retailers as virtually generated planograms based on the corresponding metrics and the corresponding correlations (see 330) and the cloud-based real-time inventory and promotional item performance monitor obtains second planograms directly from second retailers that maintain the second planograms.

At 330, the cloud-based real-time inventory and promotional item performance monitor maintains metrics and calculated correlations for the items of each store using the corresponding transaction data and the corresponding planograms.

In an embodiment, at 331, the cloud-based real-time inventory and promotional item performance monitor generates some of the metrics by processing images of shelves and displays received for each store and counts or estimates a total number of the corresponding items identified in the images on each shelf and on each display using the corresponding planograms.

At 340, the cloud-based real-time inventory and promotional item performance monitor monitors stocked inventory levels for the items associated with each store based on the corresponding metrics, the corresponding correlations, and the corresponding planograms.

At 350, the cloud-based real-time inventory and promotional item performance monitor monitors promotional conditions for promotions of the items between the retailers and the entities based on the corresponding metrics, the corresponding correlations, and the corresponding planograms.

At 360, the cloud-based real-time inventory and promotional item performance monitor selectively reports portions of the metrics, the correlations, the stocked inventory levels, and compliance levels for the promotional conditions to the retailers and the entities.

In an embodiment, at 361, the cloud-based real-time inventory and promotional item performance monitor reports summary data gathered from the transaction data, the metrics, the correlations, the stocked item inventory levels, and the compliance levels to each of the retailers and to each of the entities at recurring intervals of time.

In an embodiment, at 370, the cloud-based real-time inventory and promotional item performance monitor provides interfaces to the retailers and the entities for querying the data store, defining reports from the data store, and receiving notifications from the data store. The cloud-based real-time inventory and promotional item performance monitor also provides the interfaces to the retailers and the entities for querying their corresponding metrics, correlations, stocked inventory levels, and compliance levels.

In an embodiment, at 380, the cloud-based real-time inventory and promotional item performance monitor selectively provides select data from the transaction data, the metrics, the correlations, the stocked inventory levels, or the compliance levels to internal systems of the retailers and the entities using APIs based on processing retailer-specific workflows and entity-specific workflows.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
maintaining first metrics from sales of items at a store within a data store;
maintaining second metrics for a planogram of the items located at the store within the data store;
deriving correlations for the first metrics and the second metrics based on transaction data associated with transactions of the store and the planogram; and
monitoring, in real time, an item inventory level for a given item within the store and a performance level of a promotion for the given item within the store based on the first metrics, the second metrics, and the correlations.

2. The method of claim 1 further comprising:
sending a real-time alert to a retailer associated with the store or to an entity associated with providing the given item to the store when a given correlation for a given interval or time deviates from a previous correlation for a previous interval of time by a predefined amount or rate.

3. The method of claim 1 further comprising:
sending a real-time alert to an entity associated with providing the given item to the store when the performance level indicates the the store is violating conditions of the promotion.

4. The method of claim 1 further comprising:
sending a real-time alert to a retailer associated with the store or to an entity associated with providing the given item to the store when item inventory level for the given item indicates that the given item requires restocking to a predefined level on a stocked shelf or an endcap display of the store.

5. The method of claim 1 further comprising:
sending select data from the first metrics, the second metrics, the correlations, the item inventory level, or the performance level to an internal system of a retailer associated with the store or an entity associated with providing the given item to the store based on the item inventory level or the performance level.

6. The method of claim 1 further comprising:
sending current summary data from the first metrics, the second metrics, the correlations, the item inventory level, and the performance level as a report to a retailer associated with the store or an entity associated with providing the given item to the store at a recurring interval of time.

7. The method of claim 1 further comprising:
sending select data from the first metrics, the second metrics, the correlations, the item inventory level, and the performance level to a retailer associated with the store or an entity associated with providing the given item to the store based on processing a retailer-specific workflow or an entity-specific workflow.

8. The method of claim 1, wherein maintaining the second metrics further includes obtaining images of shelves and displays of the store from cameras located within the store and performing image processing on the images using the planogram to obtain the second metrics.

9. The method of claim 1, wherein maintaining the second metrics further includes generating the planogram based on the transaction data as a virtual planogram.

10. The method of claim 1, wherein maintaining the second metrics further includes obtaining the planogram from a retailer associated with the store.

11. The method of claim 1, wherein deriving further includes deriving at some of the correlations as sales velocities of the given item, an item category associated with the given item, and an item department associated with the given item within a current interval of time.

12. The method of claim 1, wherein deriving further includes deriving at least one correlation as a demographic for customers purchasing the given item.

13. A method, comprising:
maintaining a data store as an aggregation of transaction data that spans retailers and entities, wherein the entities comprise manufacturers, suppliers, distributors, and Consumer Packaging Goods (CPG) companies associated with items that are sold by the retailers to consumers of the retailers;
maintaining planograms for the items of stores associated with the retailers;
maintaining metrics and calculated correlations for the items of each store using the corresponding transaction data and the corresponding planograms;
monitoring stocked inventory levels for the items associated with each store based on the corresponding metrics, the corresponding calculated correlations, and the corresponding planograms;
monitoring promotional conditions for promotions of the items between the retailers and the entities based on the corresponding metrics, the corresponding calculated correlations, and the corresponding planograms; and
selectively reporting portions of the metrics, the calculated correlations, the stocked inventory levels, and compliance levels for the promotional conditions to the retailers and the entities.

14. The method of claim 13 further comprising:
providing interfaces to the retailers and the entities for querying the data store, defining reports from the data store, and receiving notifications from the data store; and
providing the interfaces to the retailers and the entities for querying their corresponding metrics, calculated correlations, stocked inventory levels, and the compliance levels.

15. The method of claim 13 further comprising:
selectively providing select data from the transaction data, the metrics, the calculated correlations, the stocked inventory levels, or the compliance levels to internal systems of the retailers and the entities using Application Programming Interfaces (APIs) and based on processing retailer-specific workflows for the retailers and based on processing entity-specific workflows for the entities.

16. The method of claim 13, wherein maintaining the planograms further includes generating and maintaining first planograms for first retailers as virtual planograms based on the corresponding metrics and the corresponding calculated correlations and obtaining second planograms from second retailers.

17. The method of claim 13, wherein maintaining the metrics further includes generating some of the metrics by processing images of shelves and displays for each store and counting or estimating a total number of the corresponding items identified in the images on each shelf and on each display using the corresponding planograms.

18. The method of claim 13, wherein selectively reporting further includes reporting summary data gathered from the transaction data, the metrics, the calculated correlations, the stocked inventory levels, and the compliance levels to each of the retailers and to each of the entities at recurring intervals of time.

19. A system, comprising:
a cloud processing environment comprising at least one server;
the at least one server comprising a processor and a non-transitory computer-readable storage medium;
the non-transitory computer-readable storage medium comprises executable instructions; and
the executable instructions when executed on the processor from the non-transitory computer-readable storage medium cause the processor to perform operations comprising:
maintaining a data store comprising transaction data for transactions, wherein the transaction data spans multiple retailers and entities, wherein the entities comprise manufacturers, suppliers, distributors, and Consumer Packaging Goods (CPG) companies associated with items that are sold by the retailers to consumers of the retailers;
generating and maintaining planograms for stores of the retailers;
obtaining promotion conditions for promotions of items being offered by the retailers, the entities, or both the retailers and the entities;
maintaining metrics and calculated correlations derived from the metrics for each of items of each store over intervals of time;
maintaining item stocked inventory levels for each item within each store based on the corresponding metrics, the corresponding calculated correlations, and the corresponding planograms;
maintaining promotion compliance levels for each item within each store based on the corresponding promotion conditions, the corresponding metrics, the corresponding calculated correlations, the stocked inventory levels, and the corresponding planograms; and
selectively reporting select data from the transaction data, the metrics, the calculated correlations, the stocked inventory levels, and the promotion compliance levels to the retailers and the entities.

20. The system of claim 19, wherein the executable instructions when executed on the processor from the non-transitory computer-readable storage medium further cause the processor to perform additional operations comprising:
sending real-time alerts to the retailers and the entities when the stocked inventory levels fall below first thresholds set in the promotion conditions or when the promotion compliance levels fall below second thresholds.
